(19) United States
(12) Patent Application Publication
(10) Pub. No.: US 2017/0147762 A1
(43) Pub. Date: May 25, 2017

(54) Method for Finding the Optimal Schedule and Route in Contrained Home Healthcare Visit Scheduling

(71) Applicant: Jonathan Vallee, (US)

(72) Inventor: Jonathan Vallee, (US)

(21) Appl. No.: 14/949,962

(22) Filed: Nov. 24, 2015

(51) Int. Cl. G06F 19/00

(52) U.S. Cl. CPC G06F 19/327

(57) ABSTRACT

A method for finding the optimal schedule and route to visit all constrained and unconstrained nodes of a graph only once while respecting the associated time windows and system constraints. The constrained nodes are first grouped in clusters based on their time windows and system constraints. Then, unconstrained nodes are optimally assigned to the clusters by using a greedy heuristic. Subsequently, enumeration is used to solve the TDTSPTW by cluster. Once all clusters are solved, the paths are joined and a local search heuristic is used to improve the solution. The result of the method is an ordered set of nodes to be visited with their associated start times.

### FIELD OF THE INVENTION

The present invention relates to the field of operations research in home healthcare. More specifically the invention relates to a methodology of finding the optimal schedules and shortest Hamiltonian path in constrained home healthcare visits scheduling and in particular to scheduling a care worker's daily constrained visits to patients.

### BACKGROUND OF THE INVENTION

Home healthcare is a labour intensive industry where costs can't be cut from services delivery. Care workers spend an important portion of their time traveling between patients. Patients are often assigned to care workers on patient intake based on skills and previous assignment to the patient's care team. Patient visits are regularly constrained by time windows, described by an earliest time of arrival and a latest time of departure. A day of work can also be constrained by sequences of visits. For example, if the care worker needs to take blood samples from two patients, it might be mandatory that the two patients be seen one after the other so that the blood can reach the laboratory as quickly as possible to preserve its quality. Also, the time it takes to travel from patient A to patient B depends on the time of departure from patient A.

When creating schedules, a care coordinator manually orders the care worker's daily visits. Oftentimes, this leads to a suboptimal solution since a user will generally provide destinations to be visited in a stream-of-consciousness manner as explained in U.S. Pat. No. 6,182,008 granted on Jan. 30, 2001 to Nikiel et al. [4].

Hence, scheduling of resources is a significant problem in home healthcare. Operations research is a field of study interested in optimizing the use of resources while respecting a set of constraints. It has shown significant improvements in a number of industry like supply chain management and workforce scheduling. A review of the prior art showed that the most successful applications of operations research follow this procedure:
1. Formulation of the problem,
2. Construction of the model, and
3. Development or use of an algorithm to solve the model

More generally, the activity of optimally ordering a number of visits constrained by earliest start and latest end times can be formulated as a time dependent traveling salesman problem with time windows (TDTSPTW), which is an important optimization problem in the field of operations research. As described by [2], the TSPTW, a version of the TDTSPTW with constant travel time, can be detailed as finding the lowest cost tour starting and ending at the same depot by visiting N customers, N being a plural integer. Each customer has a service time that represents the time that must be spent servicing it, and a time window describing the latest time by which the visit must be finished and an earliest time before which it can't be visited. The cost cᵢⱼ illustrates the duration required to go from customer i to customer j. TSPTWs belong to a class of problem, referred to as NP-Hard problems, for which no perfect solutions have been found hitherto. [5] surveyed heuristics to solve such problem but the studied approaches: simulated annealing, tabu search and genetic algorithms all lack flexibility to add constraints that are often found in home healthcare scheduling. In addition, TDTSPTW deal with different travel time dependent on the time of departure from the source node.

Algorithms have been proposed to solve the TDTSPTW problem but they are not tailored to home healthcare. [1] proposes an algorithm to solve it to optimality but it relies on commercial solvers and isn't instantaneous. Indeed, the integer programming exact solution can be found but isn't usable with the current state of computer performance above a certain limited number of graph nodes (i.e. patient visits).

Therefore, what is needed is an algorithm to solve a home healthcare TDTSPTW by providing flexibility and accuracy while being fast enough to be usable by a home healthcare coordinator or nurse.

The things that are needed: speed, flexibility and quality, will be put forth as solutions in the next section.

### SUMMARY OF THE INVENTION

The present invention overcomes the problems identified above by providing a methodology that determines the optimal schedule and shortest path that a mobile care worker should take to visit each assigned patient in the optimal order while respecting all associated constraints. In addition to a system of constraints of visits length and time dependent travel durations between patients, scheduling parameters such as earliest start and latest end times, are taken into consideration to generate the suggested order of visits.

The present invention, which achieves an acceptable level of optimization, determines the path to visit all assigned patient nodes within a day while respecting associated constraints.

The approach uses destination clustering to split the problem in smaller parts. This enables the use of enumeration to solve the pieces and then assembles the segments to form the global route. Then, a local search heuristic is used to improve the initial solution's quality. This computerized process is flexible, fast, and provides quality solutions, thus corresponds to the needs of the home healthcare field staff.

The invention accordingly comprises the several steps and the relation of one or more of such steps with respect to each of the others. All is exemplified in the following detailed disclosure and the scope of the invention will be indicated in the claims.

### BRIEF DESCRIPTION OF THE DRAWINGS

For a more complete understanding of the invention, reference is made to the following description and accompanying drawings, in which:

FIG. 1 Flow chart of the method steps of the invention;

FIG. 2 Identification of constrained graph nodes;

FIG. 3 Constrained nodes' assignation to clusters;

FIG. 4 Clusters' centroid calculation;

FIG. 5 Example of distance matrix between clusters and unconstrained nodes;

FIG. 6 Integer programming to assign unconstrained nodes to clusters;

FIG. 7 Integer programming to solve the TSPTW per cluster; and

FIG. 8 Routes concatenation between clusters.

### DETAILED DESCRIPTION OF THE PREFERRED EMBODIMENTS

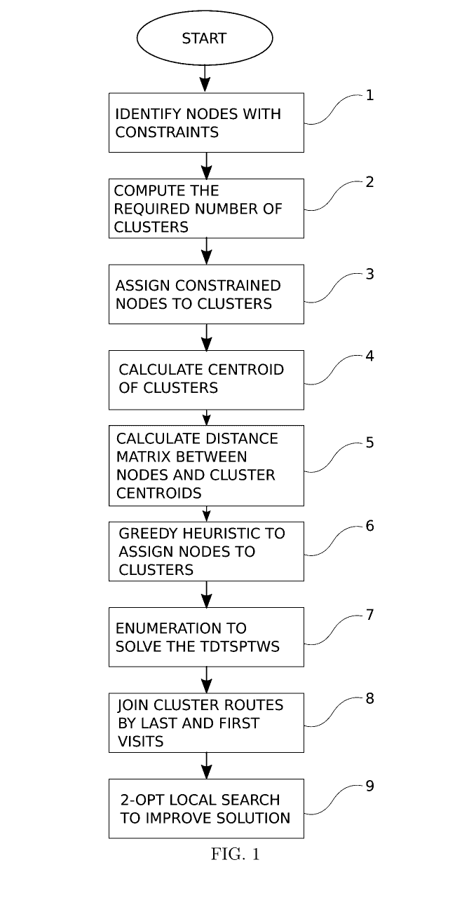

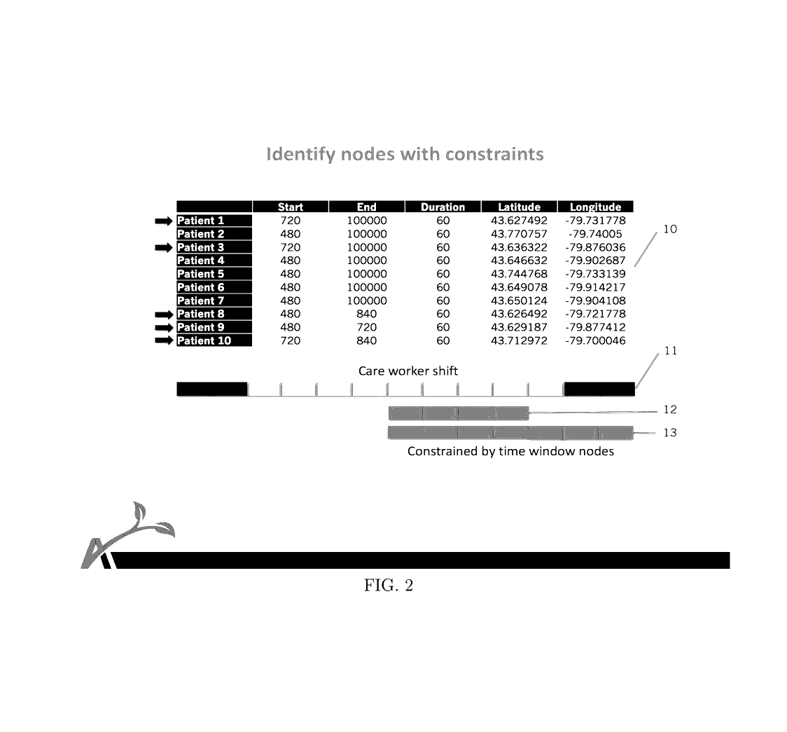

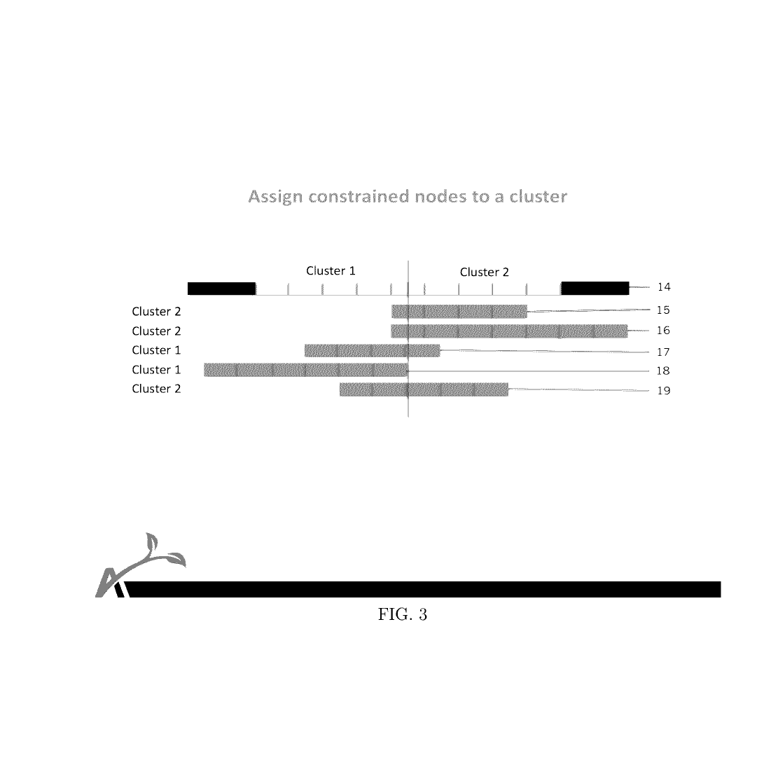

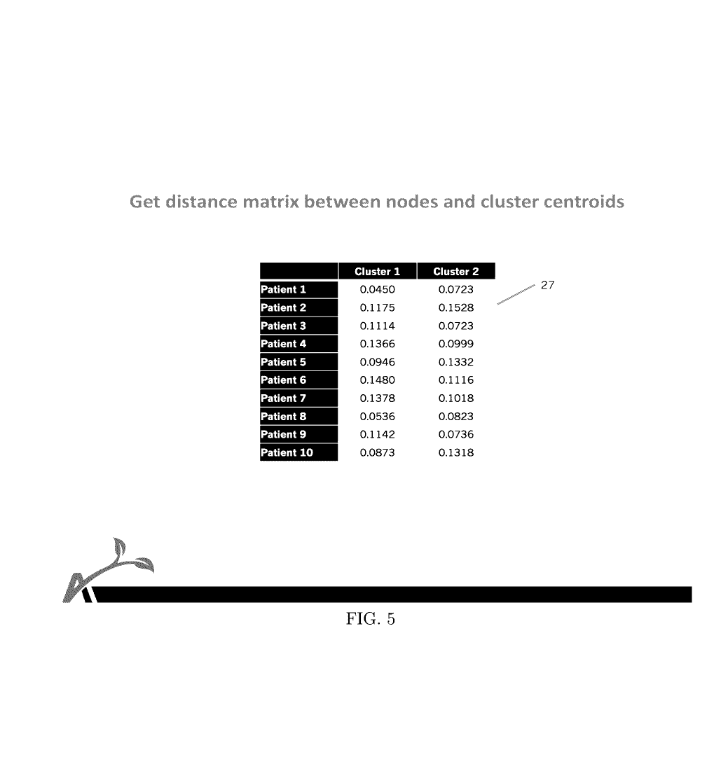

FIG. 1 shows the method steps of the invention and FIG. 2-FIG. 8 exemplify it.

Step [1] represents the identification of constrained patient visits amongst constrained and unconstrained ones. It defines a set of patient visits that limit the potential solution space by adding constraints to the optimization problem. Said constraints are described in the form of time windows that limit the period during which a patient can be visited.

[10] shows a table with 10 patient visits and the required information that is needed. “Start” and “End” represent the time window in minutes—in this case 720 means noon. “Duration” means the length of the visit in minutes and “Latitude” and “Longitude” are geographic coordinates. The shift in our example starts at 480 minutes. When “Start” is set to 480, it means that the visit doesn't have a lower bound significant to our problem since it equals the shift start time. When “End” is set to 100000, it means that the visit doesn't have an upper bound significant to our problem. [11] illustrates a care worker shift and [12] [13] two constrained visits.

Step [2] represents the operation of calculating the number of required clusters based on an input parameter n that limits the maximum number of patient visits per cluster. Let N be the number of destinations to visit during a day, thus ceiling

$$( \frac{N}{n} )$$

results in the number of required clusters.

Algorithm 1 is used to perform step [2] while also computing the clusters start and end times.

Algorithm 1: Clusters creation

| | Data: Visits and associated time windows, number of clusters, shift |
|---|---|
| | start and end time |
| | Result: Clusters with assigned time windows |
| 1 | initialization; |
| 2 | cut = (shift end time − shift start time) / number of clusters; |
| 3 | clusters start time = Array[ ]; |
| 4 | clusters end time = Array[ ]; |
| 5 | for i ← 1 to n_{c}lusters do |
| 6 | \| clustersstarttime[i] = shift start time + i * cut; |
| 7 | \|_ clustersendtime[i] = shift start time + i * cut + cut; |

In our example, N is 10 and n is 8 so the total number of required clusters is ceiling

$$( \frac{10}{8} ) = 2.$$

Step [3] represents the assignment of constrained patient visits to clusters. It separates the visits in groups of maximum size n based on start and end times, and on scheduling constraints. The result of this step is a set of clusters that are comprised of constrained patient visits.

Algorithm 2 is used to perform step [3].

Algorithm 2: Constrained visits' cluster assignment

| | Data: Visits and associated time windows, clusters and associated |
|---|---|
| | time windows |
| | Result: Clusters with assigned visits |
| 1 | initialization; |
| 2 | cluster proportions = Array[,]; |
| 3 | assignment matrix = [,] for i = 0 to Length(visits) do |
| 4 | \| for j = 0 to Length(clustersstarttime) do |
| 5 | \| \| if visit[i]starttime ≧ clustersstarttime[j]andvisit[i]endtime ≦ |
| | \| \| clustersendtime[j] then |
| 6 | \| \| \|_ clusterproportions[i,j] = 1; |
| 7 | \| \| else if visit[i]starttime ≧ clustersstarttime[j]andvisit[i]- |
| | \| \| endtime ≧ clustersendtime[j] then |
| 8 | \| \| \| clusterproportions[i,j] = (clusterendtime[j] − |
| | \| \| \| visit[i]starttime)/(visit[i]endtime − visit[i]starttime); |
| 9 | \| \| else if visit[i]starttime ≦ clustersstarttime[j]andvisit[i]- |
| | \| \| endtime ≦ clustersendtime[j] then |
| 10 | \| \| \| clusterproportions[i,j] = (visit[i]endtime − |
| | \| \| \| clustersendtime[j])/(visit[i]endtime − visit[i]starttime); |
| 11 | \| \| else if visit[i]starttime < clustersstarttime[j]andvisit[i]- |
| | \| \| endtime > clustersendtime[j] then |
| 12 | \| \| \| clusterproportions[i,j] = (clustersendtime[j] − |
| | \| \| \| clustersstarttime[j]/(visit[i]endtime − visit[i]starttime); |
| 13 | \| \| else |
| 14 | \| \|_ \| clusterproportions[i,j] = 0; |
| 15 | \|_ assignment matrix[i, cluster proportion[i].argmax] = 1 |

Then, in order to include sequences of patient visits, a subsequent step is needed. Let L be a vector of sequences (a, b, . . . , n). For all sequences in L, make sure that all visits are assigned to the same cluster. If not, compute the aggregated proportion of visit time per cluster and assign all visits in a sequence to the highest proportion cluster.

[14] shows the two created clusters and [15]-[19] show constrained visits assigned to the clusters based on the proportion of their time window within the clusters' time windows. Thus, [17] and [18] are assigned to cluster 1 and [15], [16] and [19] are assigned to cluster 2.

Step [4] represents the operation of calculating the coordinates of the clusters' centroids generated in step [3] by using the following equation

$$( \frac{{\sum }_{i = 1}^{n} {x}_{i , latitude}}{{n}_{i}} , \frac{{\sum }_{i = 1}^{n} {x}_{i , longitude}}{{n}_{i}} ) \qquad ( 1 )$$

where x is the array of patient visits in cluster i and nᵢ is the number of visits in cluster i. If the cluster doesn't have any constrained visits in it, we assign the centroid of the unconstrained patient visits to it.

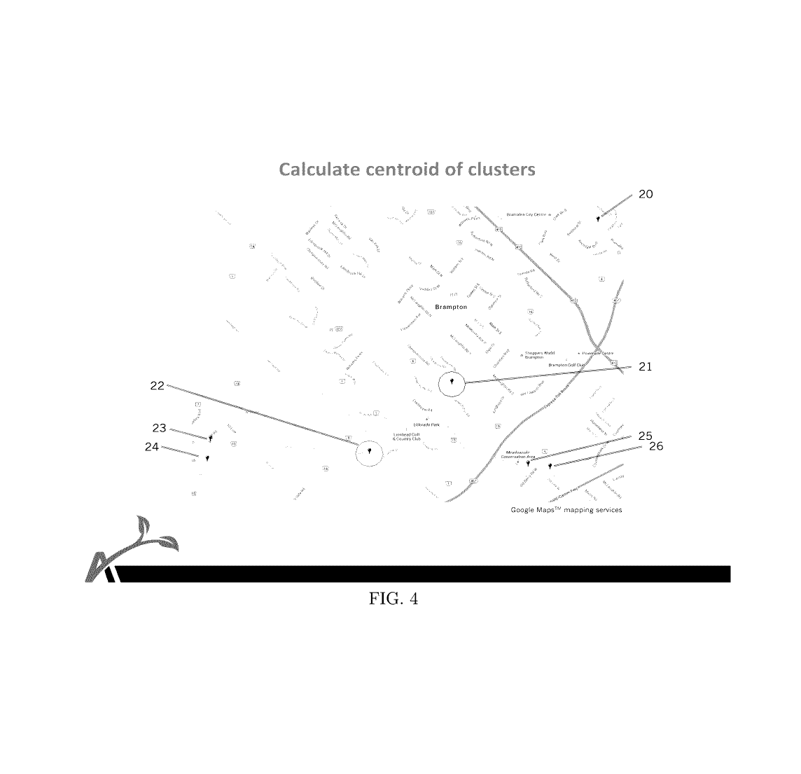

FIG. 4 shows on a map 5 constrained nodes where [23] and [25] are in cluster 1 and [20], [24] and [26] are assigned to cluster 2. [22] represents the calculated position of cluster 1's centroid while [21] represents the centroid of cluster 2.

Step [5] represents the computation of the distance matrix between the cluster's centroids and the unconstrained patient visits. [27] shows the distance matrix example.

Step [6] represents the optimal assignment of unconstrained patient visits to clusters to minimize the distance. It assigns visits to clusters based on minimum distance to cluster centroids. If the cluster gets to maximum capacity, the second best choice is selected and so on.

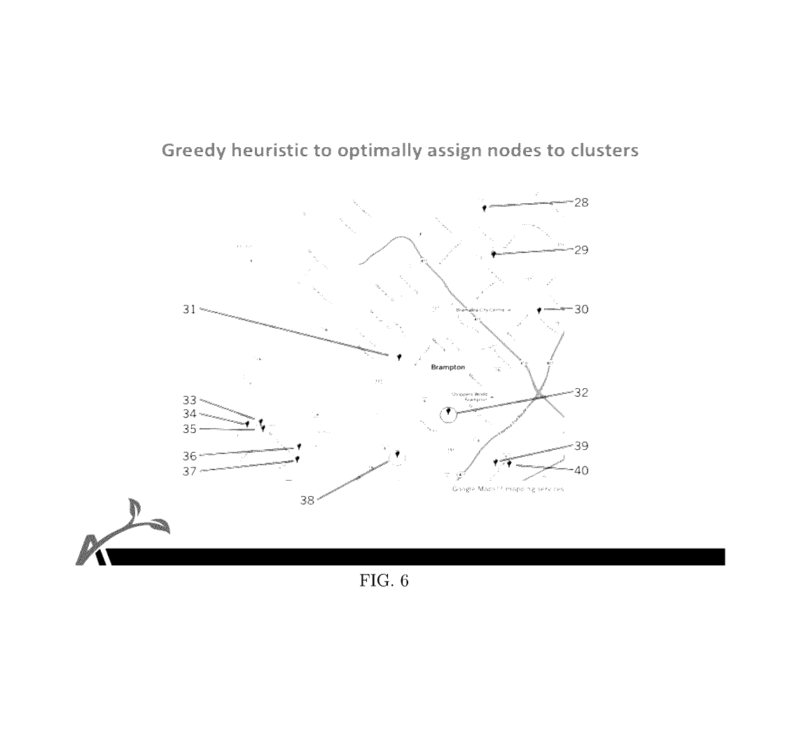

FIG. 6 shows an example of all nodes, constrained and unconstrained, assignation to clusters. [28], [29], [30], [31], [37], and [40] are assigned to cluster 2, with centroid at [32] while [33], [34], [35], [36], and [39] are assigned to cluster 1, with centroid at [38].

In total, 96 variations of the duration matrix for a complete day of 24 hours are used to compute the dᵢⱼₜ from node i to node j at time t. The time is segmented in 15 minute increments. The dᵢⱼₜ is selected based on the closest 15 minutes increment.

Step [7] represents the step of enumerating all possible paths, measure their cost as being the shift's ending time, assess their feasibility and selects the one with the minimum cost. The steps required to build the candidate shifts are as follow:

Algorithm 3: Shift creation

| | |
|---|---|
| | Data: Ordered visits and associated duration, travel duration matrix, |
| | shift start time |
| | Result: Scheduled visits |
| 1 | initialization; |
| 2 | time clock = shift start time; |
| 3 | shift = Array[ ]; |
| 4 | start times = Array[ ]; |
| 5 | for i ← 2 to length(orderedvisits) do |
| 6 | \| shift[i − 1] = ordered visits[i − 1]; |
| 7 | \| starttimes[i − 1] = time clock; |
| 8 | \| t = timeclock + ordered visits[i − 1].duration timeclock += |
| | \|_ ordered visits[i − 1].duration + distance matrix[i − 1, i, t]; |

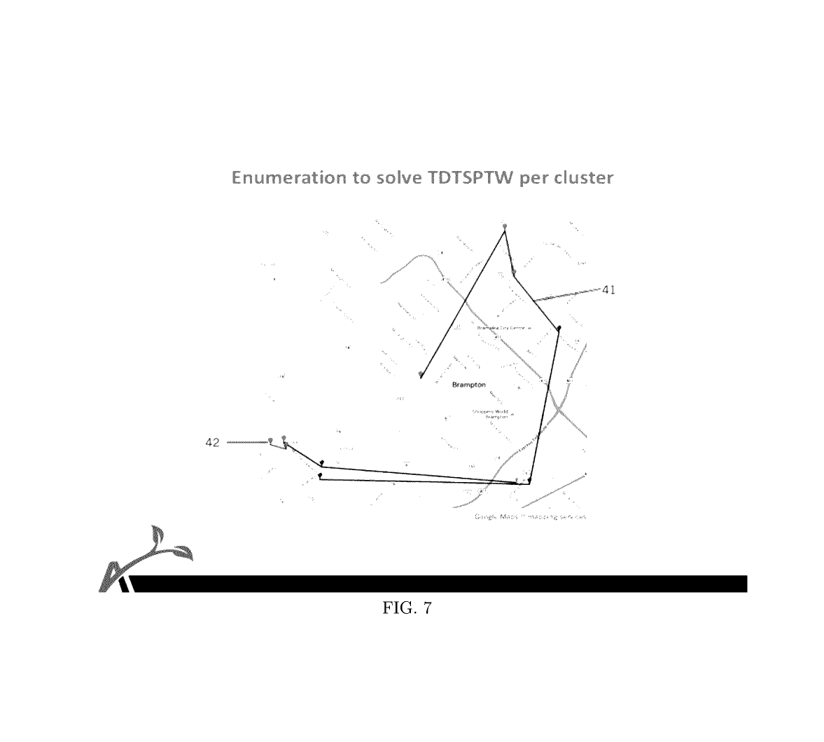

FIG. 7 shows the two solved cluster paths. [41] is cluster 2's shortest path and [42] shows cluster 1's.

Step [8] represents the operation of joining the path between the clusters. To do that, we take the latest visit of the a cluster and join it to the earliest visit of the subsequent cluster.

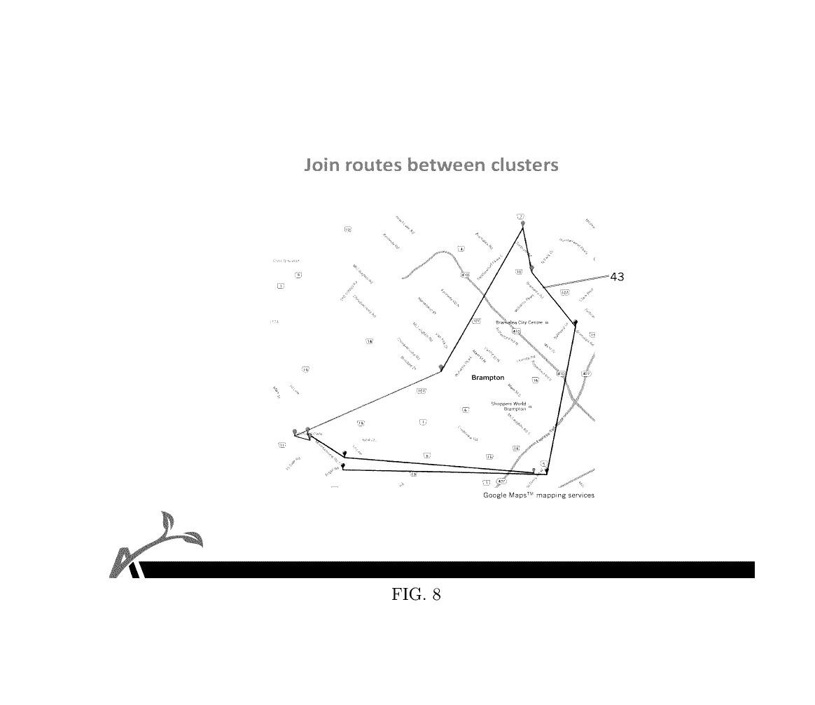

FIG. 8 shows the final path found by the heuristic. [43] is the path obtained by joining path [41] and path [42].

Step [9] represents the optional operations of trying to improve the solution found by the heuristic by using the 2-opt methodology proposed by [3].

The result is an ordered set of patient visits with start times attached to them. This will be used as a care worker's daily schedule of patients to visit.

What is claimed:

1. A method of daily scheduling planning comprising:
identifying the constrained patient visits
determining the order by which patients are going to be visited in a care worker's day of work by:
defining the required number of clusters to create
creating said clusters based on start and end time of shifts and on maximum number of patient visits per cluster
assigning constrained visits to said clusters based on time windows calculating the centroid of the said constrained clusters
calculating the distance matrix between the unconstrained patient visits and the said cluster centroids
assigning the said unconstrained visits to clusters in order to minimize total distance
enumerating the clusters' possible paths and selecting the minimal cost ones
determining the complete route by joining the said clusters' sub-routes optionally, improving the initial solution with local search heuristics

2. The method of claim 1 further comprising an equation to calculate the required number of clusters to create:
$$ceiling ( \frac{N}{N} ) \qquad ( 2 )$$
wherein N is the number of patients to visit and n is the maximum number of patient visits per cluster.

3. The method of claim 1 further comprising an algorithm to create clusters:
Algorithm 4: Clusters creation

| | Data: Visits and associated time windows, number of clusters, shift |
|---|---|
| | start and end time |
| | Result: Clusters with assigned time windows |
| 1 | initialization; |
| 2 | cut = (shift end time − shift start time) / number of clusters; |
| 3 | clusters start time = Array[ ]; |
| 4 | clusters end time = Array[ ]; |
| 5 | for i ← 1 to n_{c}lusters do |
| 6 | \| clustersstarttime[i] = shift start time + i * cut; |
| 7 | \|_ clustersendtime[i] = shift start time + i * cut + cut; |

4. The method of claim 1 further comprising an algorithm to assign constrained patient visits to clusters:
Algorithm 5: Constrained visits' cluster assignment

| | Data: Visits and associated time windows, clusters and associated |
|---|---|
| | time windows |
| | Result: Clusters with assigned visits |
| 1 | initialization; |
| 2 | cluster proportions = Array[,]; |
| 3 | assignment matrix = [,] for i = 0 to Length(visits) do |
| 4 | \| for j = 0 to Length(clustersstarttime) do |
| 5 | \| \| if visit[i]starttime ≧ clustersstarttime[j]andvisit[i]endtime ≦ |
| | \| \| clustersendtime[j] then |
| 6 | \| \| \| clusterproportions[i,j] = 1; |
| 7 | \| \| else if visit[i]starttime ≧ clustersstarttime[j]andvisit[i]- |
| | \| \| endtime ≧ clustersendtime[j] then |
| 8 | \| \| \| clusterproportions[i,j] = (clusterendtime[j] − |
| | \| \| \| visit[i]starttime)/(visit[i]endtime − visit[i]starttime); |
| 9 | \| \| else if visit[i]starttime ≦ clustersstarttime[j]andvisit[i]- |
| | \| \| endtime ≦ clustersendtime[j] then |
| 10 | \| \| \| clusterproportions[i,j] = (visit[i]endtime − |
| | \| \| \| clustersendtime[j])/(visit[i]endtime − visit[i]starttime); |
| 11 | \| \| else if visit[i]starttime < clustersstarttime[j]andvisit[i]- |
| | \| \| endtime > clustersendtime[j] then |
| 12 | \| \| \| clusterproportions[i,j] = (clustersendtime[j] − |
| | \| \| \| clustersstarttime[j]/(visit[i]endtime − visit[i]starttime); |
| 13 | \| \| else |
| 14 | \| \|_ \|_ clusterproportions[i,j] = 0; |
| 15 | \|_ assignment matrix[i, cluster proportion[i].argmax] = 1 |

5. The method of claim 4 further comprising a step to assign sequences of visit to the same cluster.

6. The method of claim 1 further comprising an equation to compute the clusters' centroids defined as follows:
$$( \frac{{\sum }_{i = 1}^{n} {x}_{i , latitude}}{{n}_{i}} , \frac{{\sum }_{i = 1}^{n} {x}_{i , longitude}}{{n}_{i}} ) \qquad ( 3 )$$

7. The method of claim 1 further comprising the use of distance and duration matrices by 15 minutes increment by day of the week.
